(19) United States
(12) Patent Application Publication
(10) Pub. No.: US 2009/0126498 A1
(43) Pub. Date: May 21, 2009

(54) Pressure sensor device

(76) Inventors: Markus Gilch, Mauern (DE); Manfred Glehr, Wenzenbach (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/918,756

(22) PCT Filed: Mar. 31, 2006
(86) PCT No.: PCT/EP2006/061209

§ 371 Date: Oct. 18, 2007

(30) Foreign Application Priority Data
Apr. 18, 2005 (DE) 10 2005 017 853.7

(51) Int. Cl. G01L 19/04; G01L 7/08

(52) U.S. Cl. 73/708; 73/715

(57) ABSTRACT

The invention relates to a pressure sensor device comprising a membrane body in the form of a membrane whose first side is exposed to a working medium whereas the second side thereof is arranged oppositely to the first side. The inventive device also comprises at least one pressure sensor element (16, 18) for detecting the extension or compressive strain of the membrane body produced by the working medium pressure. A temperature sensor element (22) for detecting the membrane body temperature is mounted thereon.

The invention relates to a pressure sensor device which is suitable, in particular, for detecting high pressures. Pressure sensor devices are used, in particular, to detect the fuel pressure in a fuel supply of an internal combustion engine.

DE 198 33 712 discloses a pressure sensor device having a diaphragm body which has a cylindrical recess. A working medium is situated in the cylindrical recess. A diaphragm is formed in the diaphragm body, to be precise in such a manner that it adjoins the recess. A sensor chip is arranged on the diaphragm, to be precise concentrically with respect to the cylindrical recess. Sensor elements are arranged on the sensor chip in a centrosymmetrical manner with respect to the center point of the sensor chip and the axis of the cylindrical recess. The sensor elements are electrically connected in the form of a Wheatstone bridge and generate a sensor signal which represents the pressure of the working medium.

US 2002/013 41 64 A1 discloses a pressure sensor device having a diaphragm body which comprises a diaphragm. The diaphragm has a first side to which a working medium is applied. It also has a second side which is opposite the first side. In addition, it has a sensor chip on which sensor elements are arranged, said sensor elements being electrically connected in the form of a Wheatstone bridge and generating a measurement signal which represents the pressure in the working medium. The sensor elements are arranged in a corner region of the sensor chip. They are also arranged very closely adjacent to one another.

The object of the invention is to provide a pressure sensor device which makes it possible to accurately determine the pressure.

The object is achieved by means of the features of the independent patent claim. Advantageous refinements of the invention are characterized in the subclaims.

The invention is distinguished by a pressure sensor device having a diaphragm body comprising a diaphragm which has a first side to which a working medium is applied. The diaphragm also has a second side which is opposite the first side. The working medium may be gaseous, for example, but is preferably liquid.

The pressure sensor device also comprises at least one pressure sensor element for detecting extension or compression of the diaphragm body caused by the pressure of the working medium. A temperature sensor element for detecting a temperature of the diaphragm body is also arranged on the latter. The invention is based on the knowledge that, particularly in the case of very severe temporal fluctuations in the temperature of the working medium, the temporal and local temperature profile on the second side of the diaphragm and generally in the diaphragm body is very dynamic and very inhomogeneous. This may result in determination of the pressure using the pressure sensor element(s) being corrupted. Such errors can be compensated for in a simple and precise manner by providing the temperature sensor element for detecting the temperature of the diaphragm body on the diaphragm body.

According to one advantageous refinement of the invention, the temperature sensor element is arranged in the region of a junction between an extension region and a compression region of the diaphragm body, in which the pressure of the working medium causes extension or compression. The temperature sensor element is arranged on the diaphragm body. This generally ensures a physically very close arrangement with respect to the at least one pressure sensor element and the temperature profile detected using the temperature sensor element thus correlates, to a very great extent, with the temperature profile in the region of the pressure sensor element(s). In addition, the extension stress or compressive stress on the temperature sensor element is low in the junction region.

According to another advantageous refinement of the invention, the sensor element extends in the tangential and radial directions relative to a center point of the diaphragm. Its radial extent is greater than its tangential extent by a predefined factor. This makes it possible to achieve independence between the measurement signal from the temperature sensor element and the extension or compression in a particularly effective manner.

In this context, it is particularly advantageous if the factor is at least twenty. It has been found that particularly strong independence from the extension or compression is ensured in this manner.

According to another advantageous refinement of the invention, the temperature sensor element is arranged symmetrically with respect to the junction between the extension region and the compression region. This automatically compensates for extension or compression influences on the temperature sensor element.

According to another advantageous refinement of the invention, at least one pressure sensor element is arranged in the extension region of the diaphragm body and at least one further pressure sensor element is arranged in the compression region of the diaphragm body.

According to another advantageous refinement of the invention, the at least one pressure sensor element in the extension region is electrically arranged in series with the at least one pressure sensor element in the compression region in a first branch of a Wheatstone bridge and a first voltage tap is electrically provided between the pressure sensor elements. The temperature sensor element is arranged in a second bridge branch of the Wheatstone bridge and a second voltage tap is provided in the second bridge branch, the pressure sensor device being designed to tap off the voltages applied to the first and second voltage taps in a high-impedance manner. This enables, on the one hand, very effective temperature compensation and, on the other hand, diagnosis of the pressure sensor elements and of the temperature sensor element.

According to another advantageous refinement of the invention, provision is made of a voltage source which is electrically connected to the Wheatstone bridge in such a manner that it supplies the first and second bridge branches with voltage, a third voltage tap being provided at the Wheatstone bridge, a supply voltage of the voltage source being able to be tapped off via said third voltage tap, and the pressure sensor device being designed to tap off the voltage applied to the third voltage tap in a high-impedance manner. This makes it possible to carry out a diagnosis in a simple manner in order to determine whether the voltage source actually feeds a predefined supply voltage into the Wheatstone bridge and whether the first or the second pressure sensor element or the temperature sensor element is electrically short-circuited.

According to another advantageous refinement of the invention, the pressure sensor device is designed to determine the pressure of the working medium on the basis of the measurement signal from the temperature sensor element and the measurement signal(s) from the pressure sensor element(s) using a family of characteristics. This makes it possible to determine the pressure of the working medium in a simple and precise manner.

Exemplary embodiments of the invention are explained in more detail below using the schematic drawings, in which:

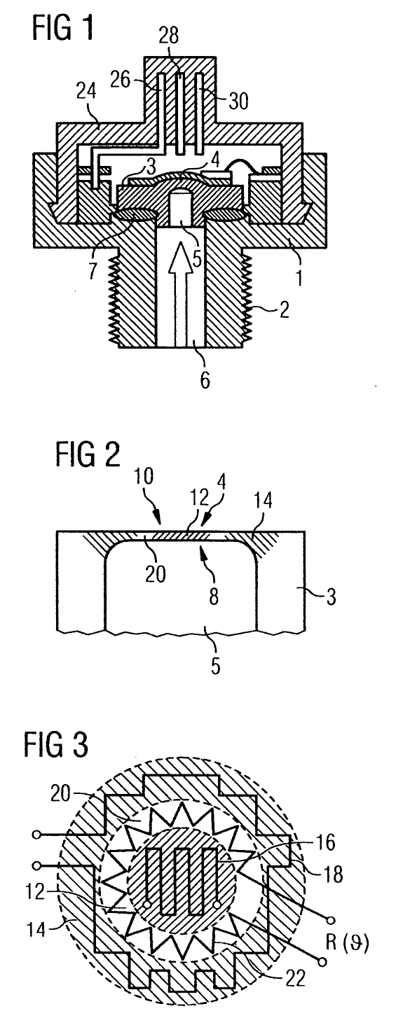

FIG. 1 shows a pressure sensor device,

FIG. 2 shows a detailed view of a diaphragm body,

FIG. 3 shows a plan view of a first embodiment of the diaphragm body,

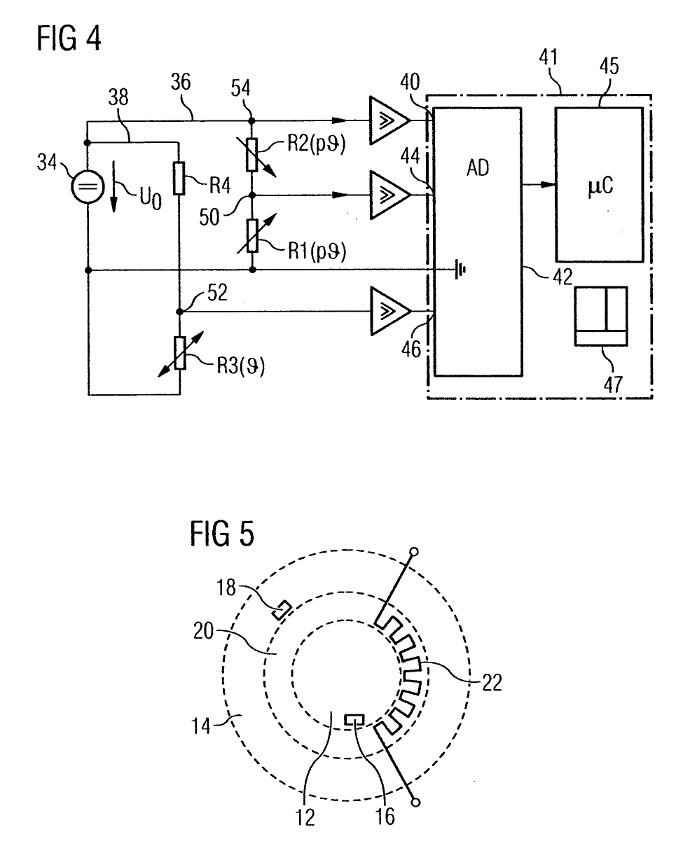

FIG. 4 shows an electrical equivalent circuit diagram of the pressure sensor device, and

FIG. 5 shows a plan view of a second embodiment of the diaphragm body.

Elements of identical design or function have been labeled using the same reference symbols throughout the figures.

A pressure sensor device (FIG. 1) comprises a first housing part 1 having an outer thread 2 which can be screwed into a corresponding counterthread. The counterthread may be formed, for example, in a fuel supply device of a motor vehicle, in particular in a common rail. In such fuel supply devices, fuel is at a pressure of up to approximately 2000 bar during operation of the internal combustion engine. Alternatively and preferably, the first thread may also be arranged in the region of an engine block or a cylinder head of the internal combustion engine in such a manner that a cylinder pressure of the respective cylinder can be detected.

The pressure sensor device also comprises a diaphragm body 3 having a diaphragm 4. The diaphragm body 3 has a cylindrical recess 5 which it uses to communicate with the working medium 6. A first side 8 of the diaphragm 4 adjoins the cylindrical recess 5. The diaphragm 4 also has a second side 10 which is remote from the cylindrical recess 5.

The diaphragm 4 has an extension region 12 (FIG. 2) in which the second side 10 of the diaphragm 4 is subjected to an extension stress when an appropriately high pressure is applied to the working medium 6. The diaphragm also has a compression region 14 on its second side 10, said region being subjected to a compression stress when a suitable pressure is appropriately applied to the working medium 6. In addition, a junction region 20, in which extension changes to compression, is formed on the second side 10 of the diaphragm 4.

At least one pressure sensor element 16, 18 is arranged on the second side 10 of the diaphragm 4. Two pressure sensor elements 16, 18 (FIG. 3) are arranged in a first embodiment. One pressure sensor element 16 is arranged in the extension region 12. The other pressure sensor element 18 is arranged in the compression region 14. The pressure sensor elements 16, 18 are preferably in the form of extension measuring elements and change their electrical resistance on the basis of a bending stress. The pressure sensor elements 16, 18 are preferably integrated in a chip which is applied to the second side 10 of the diaphragm 4.

Particularly when the pressure sensor device for detecting the cylinder pressure in the cylinder of the internal combustion engine is arranged in the latter, the working medium 6 is subject to very severe temperature fluctuations caused by the working cycles of the cylinder. Temperature changes of approximately 1000 degrees Celsius may thus arise in a period of fractions of milliseconds under certain circumstances. This results in thermal pulses periodically being applied to the diaphragm body 3. However, the diaphragm body 3 has a relatively small material thickness in the region of its diaphragm 4, whereas it has a very large material thickness relative to the latter in other regions. This results in different heat dissipation from the wall of the cylindrical recess. For this reason, a very inhomogeneous and unsteady temperature distribution results inside the diaphragm body 3. The pressure sensor elements 16, 18 generally also have a temperature-dependent measurement characteristic. Without the provision of further measures, this results in an undesirable measurement error being able to arise if the temperature of the working medium 6 is very unsteady.

A temperature sensor element 22 is arranged on the second side 10 of the diaphragm 4 in the junction region 20. The temperature sensor element 22 may also be arranged on the diaphragm body 3 outside the junction region 20. However, arranging the temperature sensor element in the junction region 20 has the advantage that the pressure sensor elements 16, 18 are closely adjacent to one another and a highly comparable temperature profile thus arises. In addition, the extension and compression are relatively low in the junction region 20. This thus makes it possible to reduce a measurement error of the temperature sensor element 22 caused by extension or compression.

As illustrated in FIG. 3, the temperature sensor element 22 may essentially extend over the entire circumference of the junction region. However, it may also extend only over part of the circumference of the junction region. The temperature sensor element is preferably a temperature-dependent resistor R3. The resistor R3 may extend along the junction region in the form of a web. It may have the zigzag form illustrated in FIG. 3 or else another form. It may also extend only over part of the circumference or may be in the form of a compact resistance element, for example in the form of a rectangle. The temperature sensor element 22 is preferably arranged such that it is symmetrical with respect to the junction between the extension region 12 and the compression region 14. A particularly high level of independence from extension or compression results if the temperature sensor element 22 extends in the tangential and radial directions relative to the center point of the diaphragm 4 and its radial extent is greater than its tangential extent by a predefined factor. The factor is preferably at least 20. In this case, the temperature sensor element 22 has an annular meandering form, as is illustrated, for example, using the further embodiment of FIG. 5.

FIG. 4 illustrates an electrical equivalent circuit diagram of the pressure sensor device. R1 is the bending-dependent resistor of the pressure sensor element 16, which is also dependent on the temperature. R2 is the bending-dependent resistor of the pressure sensor element 18, which likewise has a temperature-dependent component. R3 is the temperature-dependent resistor of the temperature sensor element 22, which, if appropriate, is also at least slightly dependent on bending. R4 is a further resistor.

Provision is made of a voltage source 34 which generates a predefined voltage U0. The resistor R2 is connected to the voltage source via a first supply line 36. The resistor R2 and the resistor R1 are electrically arranged in series with the voltage source 34. Provision is made of a second supply line 38 which connects the resistor R4 to the voltage source 34 in an electrically conductive manner. The resistor R4 is connected in series with the resistor R3. The resistors R1, R2, R3, R4 are electrically connected in the form of a Wheatstone bridge, the resistors R1 and R2 being situated in a first bridge branch and the resistors R3 and R4 being situated in a second bridge branch.

A first voltage tap 50 is electrically provided between the resistors R2 and R1. The voltage which is applied to said tap is passed in a high-impedance manner, for example by interposing an amplifier, to a second input 44 of an AD converter 42. A second voltage tap 52 is electrically provided between the resistors R4 and R3. The voltage which is applied to said second tap is passed, in a high-impedance manner, for example by interposing an amplifier, to a third input 46 of the AD converter 42. A third voltage tap 54 is electrically provided on the input side of the resistor R2 relative to the first supply line 36. The voltage which is applied to said third tap is passed, in a high-impedance manner, for example by interposing an amplifier, to a first input 40 of the AD converter 42.

Under predefined reference conditions, for example twenty degrees Celsius, the resistor R4 preferably has approximately the same resistance as the resistor R3.

Provision is also made of an evaluation unit 41 which comprises the AD converter 42 and a microcontroller 45 and preferably comprises a family of characteristics 47 in a memory provided for this purpose.

During operation of the pressure sensor device, the AD converter detects the voltages applied to its inputs 40, 44, 46 and communicates corresponding digital values of the voltages to the microcontroller 45. The microcontroller 45 is designed to determine the pressure of the working medium 6 on the basis of the digital values of the voltages at the inputs 40, 44, 46 of the AD converter 42 which have been communicated to it. This is preferably effected on the basis of a family of characteristics 47 whose input variables may be the voltages applied to the inputs 40, 44, 46 of the AD converter 42 or else variables derived from the latter and whose output variable is the pressure of the working medium 6. The pressure of the working medium 6 is preferably determined by corresponding support point interpolation of the characteristic values. However, the microcontroller 45 may also be designed to determine the pressure of the working medium 6 in another manner, for example on the basis of a calculation that is based on the Wheatstone bridge equation. In addition, the microcontroller 45 is preferably designed to carry out a diagnosis in order to determine whether the voltage source 34 actually feeds a predefined supply voltage U0 into the Wheatstone bridge and whether the first or the second pressure sensor element or the temperature sensor element is electrically short-circuited.

In alternative embodiments of the pressure sensor device, only one of the pressure sensor elements 16, 18 or a plurality of pressure sensor elements may also be provided.

The pressure sensor elements may also be arranged, for example, on the diaphragm body 4 in the manner disclosed in DE 198 33 712 or US 2002/013 41 64 A1 whose contents are hereby incorporated in this respect. In addition, a control loop may also be provided for the purpose of keeping the voltage which is applied to the resistor(s) R3 and/or R2 and/or R1 and/or R4 constant. The control loop is then designed in such a manner that an increase in a measurement voltage is compensated for by reducing a pulse-width-modulated output voltage and vice versa. It comprises a decision unit in the microcontroller 45 and a register which has sixteen bits, for example, and whose bit value is characteristic of a pulse width ratio applied to a pulse width modulation generator. The output variable of the pulse width modulation generator is supplied to a low-pass filter whose output is then electrically coupled to the respective resistor R1 to R4.

1.-9. (canceled)

10. A pressure sensor device, comprising:
a diaphragm body including a diaphragm with a first side exposed to a working medium, and a second side opposite the first side, said diaphragm having a compression region which is compressed and an extension region which is extended in response to a pressure of said working medium;
at least one pressure sensor element detecting the extension or the compression of said diaphragm caused by the pressure of said working medium; and
a temperature sensor element detecting a temperature of said diaphragm body, said temperature sensor element being arranged on said diaphragm body between said extension region and said compression region.

11. The pressure sensor device of claim 1, wherein said temperature sensor element extends tangentially and radially relative to a center point of said diaphragm, wherein a radial extent of said temperature sensor element is greater than a tangential extent by a predefined factor.

12. The pressure sensor device of claim 11, wherein the predefined factor is at least twenty.

13. The pressure sensor device of claim 10, wherein said temperature sensor element is arranged symmetrically with respect to said junction between said extension region and said compression region.

14. The pressure sensor device of claim 10, wherein said at least one pressure sensor element includes at least one first pressure sensor arranged in said extension region of said diaphragm body and at least one second pressure sensor element arranged in said compression region of said diaphragm body.

15. The pressure sensor device of claim 14, wherein said at least one first pressure sensor element is electrically arranged in series with said at least one second pressure sensor element in a first branch of a Wheatstone bridge and a first voltage tap is electrically provided between said at least one first pressure sensor element and said at least one second sensor element, and said temperature sensor element is arranged in a second bridge branch of said Wheatstone bridge, a second voltage tap being provided in said second bridge branch, said pressure sensor device being configured to tap off the voltages applied to said first and second voltage taps using high-impedance connections.

16. The pressure sensor device of claim 15, further comprising a voltage source electrically connected to said Wheatstone bridge in such a manner that it supplies a supply voltage to said first and second bridge branches, and a third voltage tap provided at said Wheatstone bridge, said pressure sensor device being configured to tap off the supply voltage applied to said third voltage tap using a high-impedance connection.

17. The pressure sensor device of claim 10, further comprising an evaluation unit configured to determine the pressure of said working medium based on a measurement signal from said temperature sensor element and a measurement signal from said at least one pressure sensor element using a family of characteristics.

18. The pressure sensor device of claim 16, further comprising an evaluation unit connected to said first, second, and third voltage taps by the respective high impedance connection, said evaluation unit being configured to the pressure of said working medium based on voltages applied to said first, second and third voltage taps.
